(19) United States
(12) Patent Application Publication
(10) Pub. No.: US 2022/0361511 A1
(43) Pub. Date: Nov. 17, 2022

(54) FRESH-CHEESE-BASED SPREAD FOR A SNACK PRODUCT

(71) Applicant: Hama Foodservice GesmbH, Hof bei Salzburg (AT)

(72) Inventors: Rudolf HAINDL, Salzburg (AT); Johann MANDL, Pfunds (AT)

(21) Appl. No.: 17/877,202

(22) Filed: Jul. 29, 2022

Related U.S. Application Data
(63) Continuation of application No. PCT/AT2021/060030, filed on Jan. 28, 2021.

(30) Foreign Application Priority Data
Jan. 31, 2020 (AT) 50079/2020

(51) Int. Cl. A21D 13/31; A21D 13/043; A21D 13/047; A21D 13/60; A23C 19/09

(52) U.S. Cl. CPC A21D 13/31; A21D 13/043; A21D 13/047; A21D 13/60; A23C 19/09

(57) ABSTRACT

A spread for a snack product includes a dough piece, particularly produced from potatoes, bread doughs and/or rice. The spread has a cheese component that consists of fresh cheese and cheese of at least one further cheese type, and a sauce component having a cream content and a starch content added to the spread. A snack product which includes the spread arranged on the dough piece is also provided. Furthermore, a method for producing a snack product includes pressing the spread into or folding the spread into the dough piece in frozen form.

### BACKGROUND OF THE INVENTION

The invention relates to a topping for a snack product with a dough piece, in particular produced from potatoes, bread doughs, and/or rice. The topping comprises a cheese component consisting of fresh cheese and cheese from at least one further cheese group. The invention furthermore relates to a snack product with such a topping and a method for producing such a snack product.

For the purposes of the present application, by a topping for a snack product is meant both a layer in the form of a topping arranged on the outside of a dough piece and a filling arranged inside a dough piece.

In the case of snack products produced from dough, toppings in the above sense are usually introduced into the dough piece or arranged on the dough piece before it is baked. Above all in the case of dough pieces produced from bread doughs, potatoes and/or rice, problems frequently arise because the snack product becomes too soggy due to the moisture contained in the topping or a relatively large cavity forms in the dough piece. The latter phenomenon is also known as “tunneling”. Because of the high water content of fresh cheese, this applies in particular to toppings which contain fresh cheese. However, toppings with fresh cheese are popular with consumers, as the snack products produced therewith as a rule are tasty and moist. If the snack products produced are soggy or have developed tunnels, however, the end product is inadequate, as a poorer taste experience is thus combined with a shortened shelf life, which is not desired by retailers and consumers alike.

There may be a lower risk of sogginess or tunneling in the case of toppings consisting of processed cheese. However, to produce processed cheese, cheese is normally shredded, blended with water and emulsifying salts, emulsifiers, stabilizers and starch and heated, and then cooled and portioned. This type of preparation is no longer up-to-date from a nutritional point of view, however.

### SUMMARY OF THE INVENTION

The object of the present invention is to avoid the above disadvantages. In particular, a nutritionally sensible and tasty topping containing cheese is to be provided, which can be arranged in or on a dough piece produced from potatoes, bread doughs and/or rice before the further processing by means of crisping-up or deep-frying, without being in danger of the snack product becoming soggy or developing tunnels during the crisping-up or deep-frying.

This object is achieved by a topping with the features of claim 1. Further advantageous embodiments of the invention are defined in the dependent claims.

The topping according to the invention is a snack product with a dough piece, in particular produced from potatoes, bread doughs, and/or rice. The topping contains a cheese component consisting, for one thing, of fresh cheese, which provides the topping with the moisture necessary for a moist end product. By fresh cheese is meant, according to the German Cheese Regulation, a cheese which has a water content in the fat-free cheese mass of over 73 wt.-%, wherein the fat-free cheese mass is the total cheese mass including the water content but without the fat content.

To vary the taste, constituents such as herbs, fruit, etc. can be added to the fresh cheese. Because of the fresh cheese proportion, the topping has a creamy consistency and can therefore also be called cream cheese. This consistency makes it easier to produce snack products according to the invention.

In addition to fresh cheese, the cheese component comprises cheese from at least one further cheese group, which for one thing also has a taste-forming effect for the desired cheese taste and for another thing has a lower water content, whereby the proportion of dry matter in the topping is increased. By dry matter is meant the constituent that is left over after the mass of the water contained has been subtracted. With the fresh cheese and the cheese of the further cheese group, a topping for savory snack products with a dough piece produced from potatoes, bread doughs, rice or a combination thereof can be obtained.

The sauce base acts as emulsifier. In other words, the sauce base has emulsifying properties. Thus, if an “emulsifier in the form of a sauce base” is mentioned in this application, then it means those emulsifying properties or that emulsifier function which the sauce base (specifically the natural emulsifiers contained in the sauce base) takes on.

According to the invention, an emulsifier in the form of a sauce base, which has a cream proportion and a starch proportion, is added to the topping.

A sauce base is a base material for the preparation of sauces and also soups, which has an excellent binding capacity and is essential for the consistency of these products. The sauce base acts as an additive in order to blend the cheese varieties, which cannot be mixed or can only be mixed with difficulty because of the different water content, thus in particular the fresh cheese and the cheese of the at least one further cheese group, to form an emulsion, and to stabilize it. In particular, the binding action of the sauce base also reduces the danger due to shear forces when the mixture with the cheese varieties is stirred. The heat supplied during the stirring can also be uniformly distributed in the mixture because of the sauce base. The dough piece with the topping arranged therein or thereon is suitable for baking and deep-frying, with the result that a simple production of the snack product is possible. The topping itself can be used fresh or frozen for the further processing to produce the snack product.

The addition of the emulsifier in the form of a sauce base allows a cheese component which, in addition to fresh cheese, contains a cheese from at least one further cheese group with a lower water content to be used for the topping, as a result of which the topping can have a high dry mass. The danger of sogginess and tunneling during the production of a snack product with a topping according to the invention is thereby greatly reduced. At the same time, because of the use of a sauce base with a cream proportion and a starch proportion, a balanced relationship between dry mass, fat, taste and consistency for the topping according to the invention can be achieved. The use of the cheese of the further cheese group in combination with the addition of an emulsifier in the form of a sauce base results in a high dry mass, compared with conventional toppings, which is also decisive for the shelf life of the topping.

The topping can have a creamy consistency and also meet consumer demands in terms of taste because of the emulsifier with a cream proportion and a starch proportion, which cannot easily be realized per se because of the comparatively high dry mass of the cheese component. During the baking or deep-frying process, the edges or tips of the topping can additionally be prevented from completely or partially breaking off or drying out.

The invention makes it possible to make the most of the advantages of using a cheese of a further cheese group as well as an emulsifier in the form of a sauce base with a cream proportion and a starch proportion without having to dispense with the advantages of using fresh cheese, for instance the creamy consistency and the associated easy processability. In particular, the topping according to the invention is machine-compatible and can be metered via filling stations without problems, which makes a cost-efficient production possible. However, the creamy consistency is also advantageous in the case of the manual production of snack products with toppings according to the invention, for instance in relation to the ability to be piped in a piping bag.

The consistency of the topping can be designed such that certain shapes which are advantageous during the introduction into or arrangement on dough pieces are retained during the portioning. Due to the stable shaping the topping can be placed better. It can also be possible to pre-shape the dough piece through the placing. Because of its consistency, the topping is to be portioned frictionlessly using necessary equipment such as for instance vacuum fillers. At the same time, because of the high dry mass, even during a possible residence time in the proving oven, the topping arranged in or on the dough piece does not lose its shape, does not leak out and also releases no or only a small amount of moisture to the dough piece.

Because of the high dry mass and the creamy consistency, further advantages over conventional toppings in terms of application technology result, as it is also possible not to arrange a topping according to the invention on or in the dough piece until after it has been baked through or deep-fried, while the dough piece is still in a warm state, without the topping leaking out or trickling off.

Because it is also possible to arrange the topping as a filling in or as a topping on the dough piece before the latter is baked through or deep-fried, toppings according to the invention have great advantages in terms of application technology and guarantee a perfect snack product for the end consumers. The topping according to the invention is bake-stable because of its constituents and can retain its shape during the baking or deep-frying process or at least melt in a controlled manner, without running off or out of the snack product.

A further advantage is that sauce bases with a cream proportion and a starch proportion are available as ready-made products, which is likewise conducive to the production of toppings according to the invention, because fewer starting materials need to be kept in storage. An example of a sauce base that can be used for the invention is a QimiQ® sauce base. A further advantage is that cream is as a rule lactose-free or at least already lactose-free cream can be used for the topping according to the invention. Overall, a lactose-free snack product is thus obtainable with a topping according to the invention.

In a preferred embodiment, the sauce base acting as emulsifier consists of cream and starch, thus has no further constituents. Such a sauce base contains natural emulsifiers, with the result that the addition of synthetically produced emulsifiers, which are listed under E numbers as food additives and are often used in convenience food products, can be dispensed with. As the fresh cheese can also be used without stabilizers and emulsifiers, overall a nutritionally high-quality and sensible foodstuff is provided. In addition, such a sauce base can be constructed very homogeneously with molecules lying close together, thus have a fine cell structure, as the milk molecules can blend well with the starch molecules and can sometimes also form a bond. The sauce base thereby offers a particularly good emulsion with, at the same time, high stability of the cheese component blended with the sauce base.

Due to the emulsifying property of the sauce base, which is achieved in particular through the small cell structure of a sauce base consisting of cream and starch, leaking fat can be immediately emulsified and bound, as a result of which a homogeneous mass is guaranteed for the topping according to the invention, which also no longer becomes unmixed or separates later.

The topping can be deposited on the dough piece or placed in the dough piece both fresh and frozen, for example as a stick. The finished topping mass can be molded into different shapes because of its consistency after production. The finished dough pieces, which are provided with a topping placed therein or thereon, can be stored frozen ready-made, taken out and then baked or deep-fried for the end consumers. This concept is easy to implement and answers staffing problems and meets the high demands of the end consumers. At the same time, regionality and short logistical distances can be taken into account.

For the further processing, the mass for the topping can still be blended with up to 60 wt.-% of other raw materials, such as for example eggs, bacon, leeks, beans, spinach, feta, tomato products, etc., without losing its functionality. The mixing process can take place in normal paddle mixers or magnetic stirring machines.

Despite this admixture, the freezing stability is provided in its entirety.

According to a preferred embodiment, the proportion of the sauce base in the topping is at most 77 wt.-%, preferably between 15 wt.-% and 60 wt.-%, particularly preferably between 20 wt.-% and 40 wt.-%.

In an embodiment of the invention, the cream proportion in the sauce base is over 75 wt.-%, preferably over 90 wt.-% and quite preferably over 95 wt.-%. It has emerged that, with these values, the dangers of sogginess and tunneling are particularly small and at the same time a particularly balanced relationship between dry mass, fat, taste, and consistency for the topping according to the invention can be achieved. The fat component added because of the cream proportion also serves, in addition to the property as taste carrier, to prevent a sogginess of the dough after the baking, as a result of which the quality and shelf life of the snack products according to the invention is prolonged.

In a further embodiment of the invention, the cream in the sauce base has a fat proportion of between 10 and 32 wt.-%, preferably 15 wt.-%. A particularly balanced relationship between dry mass, fat, taste and consistency for the topping according to the invention can thereby likewise be achieved.

In a further embodiment of the invention, the starch proportion in the sauce base is between 1 and 6 wt.-%, preferably between 2.5 and 4 wt.-%. The starch contained in the sauce base increases the stability of the mixture of the sauce base with the cheese component. Because emulsions are often unstable mixtures, it has emerged that a starch proportion lying in this range can combine larger fat-water ranges, as a result of which the effect of the interfacial energy is reduced and the mixture thereby becomes more stable overall. As a result, the risk that an unmixing results from the heat of rotation supplied during the stirring in the production can also be reduced.

In a further embodiment of the invention, the starch of the sauce base consists at least partially, preferably entirely, of tapioca and/or waxy corn starch. Both types of starch have emulsifying properties and can thus strengthen the action of the emulsifier in the form of a sauce base. In addition, the subjective mouth feel of the topping is improved by these types of starch. In particular, in the case of a mixture of the types of starch, the above-described stabilization effect is particularly great.

In a further embodiment of the invention, the proportion of the cheese from at least one further cheese group is between 8 and 30 wt.-%, preferably between 10 and 22 wt.-% and quite preferably between 15 and 20 wt.-%. This is the cheese component minus the fresh cheese proportion. These values have proved to be favorable for the processability and for the taste lies.

In a further embodiment of the invention, the proportion of fresh cheese in the cheese component is over 15 wt.-%, preferably over 25 wt.-%. These values bring about a particularly creamy consistency of the topping and, along with it, a particularly advantageous processability.

In a further embodiment of the invention, the further cheese group is hard cheese, semi-hard cheese and/or semi-soft cheese. Hard cheese is a cheese group which is characterized by a particularly high dry mass. The high dry mass and the long maturing time result in a strong taste and an intense aroma. According to the German Cheese Regulation, hard cheese may contain at most 56 wt.-% water content in the fat-free cheese mass. By semi-hard cheese is meant, according to the German Cheese Regulation, a cheese with a water content in the fat-free cheese mass of between 54 wt.-% and 63 wt.-%. By semi-hard cheese is meant, according to the German Cheese Regulation, a cheese with a water content in the fat-free cheese mass of between 61 wt.-% and 69 wt.-%.

In a further embodiment of the invention, the cheese component comprises at least three different cheese varieties. These can be cheese varieties from two, three or more different cheese groups, for example a fresh cheese, a cheese variety of the cheese group hard cheese and a cheese variety of the cheese group semi-hard cheese. The sauce base also acts as additive in order to blend the cheese varieties, which often cannot be mixed or can only be mixed with difficulty, of the at least one further cheese group to form an emulsion, and to stabilize it.

In a further embodiment of the invention, milk powder is added to the topping, wherein the proportion of milk powder is preferably between 4 and 8 wt.-%. The milk powder serves to achieve a higher dry mass with a better taste experience.

In a further embodiment of the invention, starch, preferably waxy corn starch, is added to the topping, wherein the proportion of the separately added starch can be between 2 and 6 wt.-%, preferably between 3 and 5 wt.-%. The starch supplied separately from the sauce base acts as consistency regulator.

In a further embodiment of the invention, plant fibers, preferably wheat fibers, are added to the topping, wherein the proportion of added plant fibers can be between 0.2 and 4 wt.-%, preferably between 0.4 and 1.5 wt.-%. Through the addition of the plant fibers, free water can be bound and the consistency of the topping mass can be set at a precisely determined and previously defined value. Because of their high dry mass, plant fibers have a positive effect on the bake stability, and can further improve the desired effect of the invention. Moreover, the high dry mass also has a positive effect on the freeze stability. In addition, plant fibers are pure dietary fiber, which is advantageous from a nutritional point of view. It is favorable to use plant fibers with a fineness of 30 μm or finer. Otherwise, there is a danger that the plant fibers will be noticed in the organoleptic test because of their roughness, which is rather undesired by the consumers. The above advantages result in particular when wheat fibers are used.

A further advantage of using plant fibers in combination with the sauce base, in particular when it consists of cream and starch, is the avoidance of a gelatinization and an additional mucilage formation of the topping mass. This is advantageous both for the processing and for the taste.

The ingredients of an embodiment of a topping according to the invention for a mass of 190.3 kg are listed below:

| Ingredients: | Proportion (kg): | Proportion (wt.-%): |
|---|---|---|
| QimiQ ® sauce base | 60.0 | 31.58 |
| water | 6.0 | 3.15 |
| water vapor | 14.0 | 7.36 |
| Rupp ® fresh cheese | 50.0 | 26.27 |
| Bergkäse | 20.0 | 10.51 |
| Emmental | 15.0 | 7.88 |
| skimmed milk powder | 12.5 | 6.57 |
| Novation ® 5600 | 7.0 | 3.68 |
| table salt | 1.5 | 0.788 |
| trisodium citrate | 3.0 | 1.576 |
| lactic acid | 0.5 | 0.263 |
| plant fibers | 0.8 | 0.420 |

The QimiQ® sauce base consists of a cream proportion amounting to 97 wt.-% and a starch proportion in the form of native starch amounting to 3 wt.-%. In addition to fresh cheese, two further cheese varieties, namely Bergkase and Emmental, are contained in the mass for the topping. These cheese varieties both belong to the cheese group hard cheese.

In the case where the topping of the above embodiment is to be enriched, in this embodiment another 400 g scrambled eggs, 80 g bacon and 20 g herbs can be mixed into a topping mass of 350 g before the topping is portioned and molded.

For the production of an exemplary embodiment of a topping according to the invention, a sauce base, for instance consisting of cream in a proportion of 97 wt.-% and a starch consisting of tapioca and waxy corn starch in a proportion of 3 wt.-%, for example a QimiQ® sauce base, with water is provided cold. A Bergkase and an Emmental, from the cheese group hard cheese, are used for the cheese component. To improve the taste experience, it can be a mature cheese. To make the binding easier, both cheese varieties are broken up to a piece size of from 2 to 3 mesh. For this purpose, for instance a Stephan® cutter or a special cheese stirring tank, for instance from Plevnik®, with a volume sufficient for the amount of topping mass to be produced can be used. The sauce base/water mixture is then added to the broken-up cheese varieties. Alternatively, it is also possible to blend the sauce base/water mixture with the cheese varieties in the cutter or stirring tank, and only then to shred the resultant mixture.

The above-mentioned cutters and cheese stirring tanks are suitable for a thermal treatment of the contents of from approximately 0° C. up to 100° C. The heating can be effected via a connected external hot water system and a connected external ice water system. Both a uniform heating and a uniform cooling of the mass arranged in the cutter or cheese stirring tank can thereby be guaranteed. In addition, the pasteurization can also be effected in the cutter or cheese stirring tank, wherein this is adapted to the energy sources present.

In an embodiment, the topping mass can contain dry products such as milk powder, starch, for instance in the form of Novation® 5600, table salts, plant fibers, for example in the form of wheat fibers, and lactic acid. These substances are premixed in the cold state and then dispersed, clump-free, in the mass arranged in the cutter or cheese stirring tank.

While being stirred constantly, the topping mass is heated slightly, wherein this temperature range is maintained for the starch to swell, until the pre-mix, thus the powdered dry products supplied in the form of a ready-made mixture, can dissolve well. Then the rotational speed in the cutter or cheese stirring tank can be increased until a homogeneous topping mass forms. The number of revolutions per minute must not be set too high, in order to prevent the starch from being destroyed by shear forces. The mixture of sauce base and cheese mass is now slowly heated to a temperature sufficient for the pasteurization, for example 85° C., and then maintained so that the cheese can melt slowly and evenly.

After that, the fresh cheese with a fat content of approx. 30-31 wt.-%—this corresponds to a fat proportion in the dry mass of approx. 65% without additions such as for instance synthetic emulsifiers or stabilizers—is added to the remaining mass with the water vapor and mixed in the cutter or cheese stirring tank. If the topping mass no longer has the temperature sufficient for the pasteurization, the topping mass is heated to this temperature. Due to the emulsifying property of the sauce base, which is achieved in particular through the small cell structure of a sauce base consisting of cream and starch, leaking fat can be immediately emulsified and bound, as a result of which a homogeneous mass is guaranteed for the topping according to the invention, which also no longer becomes unmixed or separates later.

The topping mass can be cooled in the cutter or cheese stirring tank and then poured out, wherein it is possible for example to pour it out into tubular bags, tubs or vacuum bags. However, it is also possible to pour out the topping mass in a heated state, whereby the bag or the tub can itself be sterilized. For sales and distribution, a tubular bag system or a vacuum bag system can be used as packaging, which ensures a hermetic storage, and a minimum shelf life long enough for the market of at least 4 to 6 months in a cooled state is thereby achieved. If the topping mass has been poured out in a heated state, the cooling of the topping mass to a core temperature of from 3 to 8° C. can preferably be effected in a cold water tank or in a cold store.

The invention furthermore relates to a snack product produced from a dough piece, in particular produced from potatoes, bread doughs and/or rice, and a topping as described above, arranged in and/or on the dough piece. In the case of an arrangement of the topping in the dough piece, it can also be said that the topping is arranged on a bottom layer of the dough piece.

The invention furthermore relates to a method for producing a snack product according to the invention, in which a dough piece is first produced from potatoes, bread doughs and/or rice in a manner known per se. In addition, a topping according to the invention is produced, wherein the topping is shaped such that it has a tapering side. For this, a Vemag® vacuum filler or a Rheon® filler can be used for example, with which the topping mass can be shaped and portioned.

According to the invention, the topping is pressed with the tapering side into the dough piece in a frozen state. After it has been pressed in, the dough piece with the topping arranged therein is crisped up or deep-fried.

The frozen and thus molded topping has the advantage that, with the tapering side, a wedge is formed, with which the topping can be better pressed into the dough piece when being arranged, as a result of which a large production depth is guaranteed. Due to the shape of the topping, the dough piece is pre-shaped such that the topping finds its place inside better.

In an embodiment of the invention, the topping is shaped for arrangement in the dough piece such that the topping has the shape of a deltoid in cross section. This shape has the advantage that the topping can be even better distributed during the baking process or during the deep-frying process, and therefore leaks out of the dough piece less easily. In addition, the topping in this shape can be stacked in a space-saving manner during the freezing.

In a further embodiment of the invention, the dough piece is cut into and the topping is pressed into the cut surface forming in the process. An even better arrangement in the dough piece is thereby achieved.

The invention furthermore relates to a method for producing a snack product according to the invention, in which a dough piece is produced from potatoes, bread doughs and/or rice and after that is rolled out flat. In addition, a topping according to the invention is produced in which the topping is shaped into a round shape, preferably in the shape of a sphere or an ellipsoid.

According to the invention, the topping is arranged on the dough piece rolled out flat in a frozen state and is then enveloped in the dough piece. Due to the shaping of the topping, the dough piece can better surround the topping, which results in a lower risk of tunneling. After that, the dough piece is crisped up or deep-fried with the topping arranged therein.

In order to meet the quality standards in the baking sector, it is often necessary to put the pastries in a proving oven, in which the temperature is not to vary too much and drafts must not occur. In the case of dough pieces which are produced from a dough in particular produced from potatoes, bread doughs and/or rice, the yeast fermentation takes place at an optimum temperature of between 33 and 37° C. However, this can be different depending on the type of dough and the size of the dough pieces.

In the case of dough pieces in which a topping according to the invention is arranged as a filling or on which a topping according to the invention is arranged as a topping, the danger of drying out in the proving oven, which often has a circulating fan, is quite large. However, this can be avoided in that the topping is placed in or on the dough piece in the frozen state and defrosts during the residence time in the proving oven, as a result of which a drying out can be prevented. A residence time of for example between 15 and 45 minutes in the proving oven can be provided. Because of the consistency of the topping according to the invention, it does not lose its shape during the residence time in the proving oven at a temperature of between 30 and 40° C., no condensing takes place and the topping releases no or barely any moisture to the dough piece, as a result of which the latter would suffer damage in terms of quality.

The production of an embodiment of a snack product according to the invention is given below:

The oven should be brought to the pre-heating temperature before it is loaded with the dough pieces, in or on which toppings according to the invention are already arranged. The pre-heating temperature often corresponds to the initial baking temperature.

After that, the dough pieces are first initially baked at a temperature of from for example 200 to 230° C. This leads to a rapid crust formation before the full oven spring sets in, and stabilizes the dough piece. A Maillard reaction should furthermore take place in the case of the toppings, as a result of which above all a crust formation and a large part of the crust aroma arise. The toppings must remain stable during the baking process and must not leak out of or run off the dough piece, which is possible in the case of toppings according to the invention. There also has to be temperature stability, as the toppings must not burn.

After an initial baking time of from approximately 5 to 10 minutes, which depends on the size of the dough piece and thus of the snack product, the temperature is lowered to for example 160 to 180° C. for the baking-through. The baking-through is effected, again depending on the size of the dough piece, over a period of from approx. 8 to 10 minutes.

The baking time specifications are always to be treated with caution. They are merely guide values, which can differ depending on the model of the oven. As a rough guide value for the total baking time for dough pieces with a total weight of from 120 to 180 g, 15 to 20 minutes can be taken as a starting point.

### BRIEF DESCRIPTION OF THE DRAWINGS

Further details and advantages of the present invention are explained in more detail below with the aid of the description of the figures with reference to the drawings.

There are shown in:

FIG. 1 a schematic representation of the method according to the invention,

FIG. 2 a schematic representation of a further method according to the invention and

FIG. 3 a schematic representation of the structure of the sauce base.

### DETAILED DESCRIPTION OF THE INVENTION

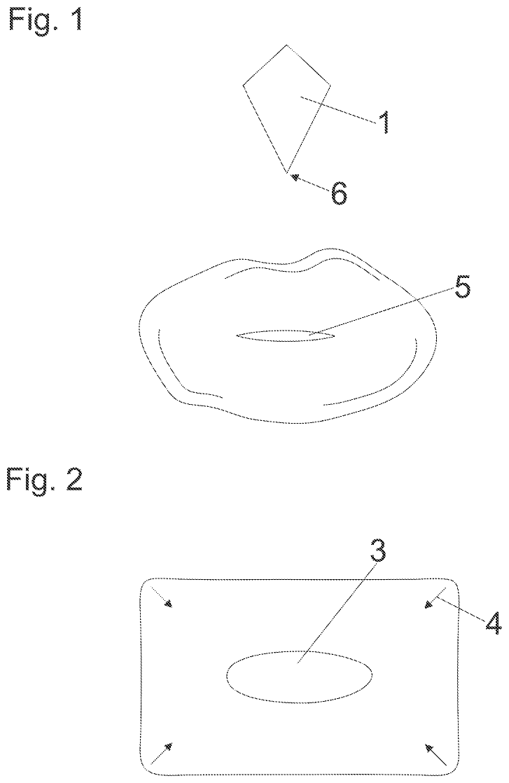

In a schematic representation, FIG. 1 shows a topping 1 according to the invention which has the shape of a deltoid in cross section. A dough piece 2 is provided with a cut 5. In a frozen state, the topping 1 is pressed into the cut 5 with the tip 6. Once the topping 1 has been pressed in, the dough piece 2 is baked through in a baking oven, as a result of which a snack product according to the invention is produced.

FIG. 2 shows a schematic representation of a further method according to the invention, wherein a topping 3 in the shape of an ellipsoid is arranged on a dough piece 4 rolled out flat. The dough piece 4 is arranged around the topping 3 in the direction of the arrows, with the result that the topping 3 is enveloped in the dough piece 4. After that, the dough piece 4 with the topping 3 enveloped in it is crisped up in a baking oven, with the result that a snack product according to the invention is produced.

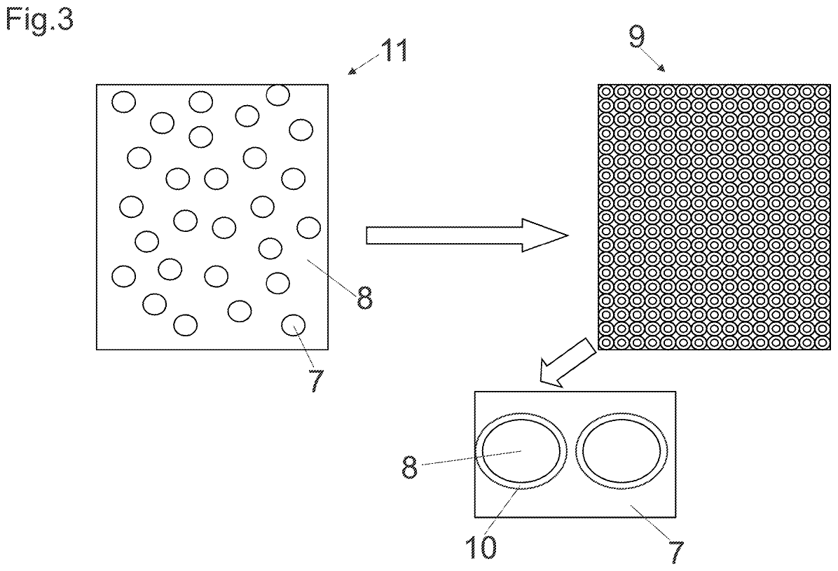

FIG. 3 shows a schematic representation of the structure of a sauce base consisting of cream 11 and starch 10. The inhomogeneous structure of a cream 11 is represented on the left-hand side, wherein the milk fat constituents 7 are distributed in a random arrangement in the rest of the milk constituents 8, including the milk proteins. Through production in a homogenizer, a sauce base 9 in which a starch proportion is added to the cream proportion can be produced, which has a very homogeneous structure with a fine cell structure. This is shown in the right-hand image. The detailed representation, arranged underneath, of a section of this image shows how the milk constituents 8, including the milk proteins, are surrounded by a starch matrix 10 and are distributed regularly in the sauce base 9. The fat constituents 7 are arranged between the milk constituents 8 surrounded by a starch matrix 10.

The thus-constructed sauce base 9 makes much more stable emulsions possible than an emulsifier in the form of pure cream 11, as a result of which toppings (1, 3) according to the invention with the desired properties can be produced.

1. A topping for a snack product with a dough piece, in particular produced from potatoes, bread doughs and/or rice, wherein the topping comprises a cheese component consisting of fresh cheese and cheese from at least one further cheese group, wherein a sauce base with a cream proportion and a starch proportion is added to the topping.

2. The topping according to claim 1, wherein the sauce base acts as emulsifier.

3. The topping according to claim 2, wherein the sauce base acting as emulsifier consists of cream and starch.

4. The topping according to claim 1, wherein the proportion of the sauce base in the topping is at most 77 wt.-%, preferably between 15 wt.-% and 60 wt.-%, particularly preferably between 20 wt.-% and 40 wt.-%.

5. The topping according to claim 1, wherein the cream proportion in the sauce base is over 75 wt.-%, preferably over 90 wt.-% and quite preferably over 95 wt.-%.

6. The topping according to claim 1, wherein the cream in the sauce base has a fat proportion of between 10 and 32 wt.-%, preferably 15 wt.-%.

7. The topping according to claim 1, wherein the starch proportion in the sauce base is between 1 and 6 wt.-%, preferably between 2.5 and 4 wt.-%.

8. The topping according to claim 1, wherein the starch of the sauce base consists at least partially, preferably entirely, of tapioca and/or waxy corn starch.

9. The topping according to claim 1, wherein the proportion of the cheese component minus the fresh cheese proportion is between 8 and 30 wt.-%, preferably between 10 and 22 wt.-% and quite preferably between 15 and 20 wt.-%.

10. The topping according to claim 1, wherein the proportion of fresh cheese in the cheese component is over 15 wt.-%, preferably over 25 wt.-%.

11. The topping according to claim 1, wherein the cheese of the at least one further cheese group is a hard cheese, a semi-hard cheese and/or a semi-soft cheese.

12. The topping according to claim 1, wherein the cheese component comprises at least three different cheese varieties.

13. The topping according to claim 1, wherein milk powder is added to the topping, wherein the proportion of milk powder is preferably between 4 and 8 wt.-%.

14. The topping according to claim 1, wherein starch, preferably waxy corn starch, is added to the topping.

15. The topping according to claim 14, wherein the proportion of added starch is between 2 and 6 wt.-%, preferably between 3 and 5 wt.-%.

16. The topping according to claim 1, wherein plant fibers, preferably wheat fibers, are added to the topping.

17. The topping according to claim 16, wherein the proportion of added plant fibers is between 0.2 and 4 wt.-%, preferably between 0.4 and 1.5 wt.-%.

18. A snack product with a dough piece, in particular produced from potatoes, bread doughs and/or rice, and the topping according to claim 1 arranged in and/or on the dough piece.

19. A method for producing a snack product comprising the following steps:
producing a dough piece from potatoes, bread doughs and/or rice,
producing the topping according to claim 1 in a shape having a tapering side, and
crisping up or deep-frying the dough piece with the topping arranged in the dough piece,
wherein the topping is pressed with the tapering side into the dough piece in a frozen state.

20. The method according to claim 19, wherein the topping has the shape of a deltoid in cross section.

21. The method according to claim 19, wherein the dough piece is cut into and the topping is pressed into the cut surface.

22. A method for producing a snack product comprising the following steps:
producing a dough piece from potatoes, bread doughs, and/or rice,
rolling the dough piece out flat,
producing the topping according to claim 1 in a round shape, preferably in the shape of a sphere or an ellipsoid, and
crisping up or deep-frying the dough piece with the topping arranged in the dough piece,
wherein the topping is arranged on the dough piece rolled out flat in a frozen state and is enveloped in the dough piece.
